(19) United States
(12) Patent Application Publication
(10) Pub. No.: US 2008/0208766 A1
(43) Pub. Date: Aug. 28, 2008

(54) System and method for an indexed debt instrument with deposit insurance pass through in a qualified program administered by an institutional investor

(75) Inventors: Michael S. Midlam, Rancho Santa Fe, CA (US); Christopher T. Gross, Encinitas, CA (US)

Correspondence Address: TERRANCE A. MEADOR;INCAPLAW, 1050 ROSCRANS STREET, SUITE K, SAN DIEGO, CA, 92106, US

(73) Assignee: Asset Marketing Systems Insurance Services, LLC, San Diego, CA (US)

(21) Appl. No.: 11/710,453

(22) Filed: Feb. 23, 2007

(51) Int. Cl. G06Q 40/00

(52) U.S. Cl. 705/36 R

(57) ABSTRACT

A system and a method for an indexed debt instrument mitigates risk perceived by an institutional investor acting as administrator of an eligible employee benefit plan when the indexed debt instrument is issued by a bank insured by the Federal Deposit Insurance Corporation (FDIC) in response to a deposit made by the institutional investor in the bank. The risk is mitigated, at least in part, by pass-through of FDIC insurance protecting the deposit. The insurance passes through the plan administrator to protect the interest of each member of the plan in the deposit, up to a defined legal limit.

### CROSS REFERENCE TO RELATED APPLICATIONS

This application contains subject matter related to the subject matter of the following commonly-owned, co-pending U.S. patent applications, all of which are incorporated herein by reference:

U.S. patent application Ser. No. 11/514,622, filed Sep. 1, 2006 for “System and Method for an Indexed Guaranteed Investment Contract”, which is incorporated herein by this reference

U.S. patent application Ser. No. 11/514,623, filed Sep. 1, 2006 for “System and Method for an Indexed Mutual Fund”; and,

U.S. patent application Ser. No. 10/981,214, filed Nov. 4, 2004 for “Indexed Annuity System and Method”.

### BACKGROUND

The subject matter concerns the sale and management of debt instruments, which are written contracts to repay debts. More particularly, the subject matter concerns an indexed debt instrument issued by an insured bank to an institutional investor for money administered by the institutional investor in a plan eligible for pass-through of deposit insurance protection.

A debt instrument is a contract obligating an issuer of the instrument to repay a debt. Typically, a debt instrument is issued by a bank to a depositor. Used as an investment, a debt instrument usually obligates the bank to return the deposit (repay the debt) with additional consideration, such as interest, to the depositor after a an agreed period of time. A debt instrument may be embodied, for example, as a bank investment contract (BIC), guaranteed investment contract (GIC), certificate of deposit (CD), or other equivalent instrument.

There has been increasing use by institutional investors of debt instruments issued by banks, as investments. Several reasons are given for this trend. For example, banks have large asset bases and considerable skill in handling and investing money. Also, institutional investors typically have considerable liquid assets, which enable them to leverage better terms in debt investment than are available to investors of average means. However, banks have historically exercised conservative approaches to analyzing and providing for risk, which have limited the features that they are willing to offer investors in debt instruments.

The features in debt instruments presently offered by banks, even to institutional investors, have historically failed to match those found in other financial products for other markets, such as retail insurance products, in scope and variety. For example, many insurance companies sell annuities with guaranteed return of principal, and with investment growth based on various market measures to which the annuities are indexed. The market risks experienced by the indexes are shared between insurer and annuitant by various means including caps, participation rates, and spreads, which may be periodically adjusted before the annuity matures. Some of these measures are starting to appear in debt instruments offered by banks to institutional investors. For example, the assignee's incorporated parent application describes bank investment contracts that are indexed to equity markets.

Nevertheless, an institutional investor may be inhibited by regulation and/or industry practice from investing in non-traditional debt instruments issued by banks. For example, a pension fund may consider depositing money from an employee retirement plan administered by the fund with a bank in connection with an indexed BIC or an indexed CD issued by the bank. Although the investment can be guaranteed by the bank against the effect of negative return (loss) in the index, the risk that positive returns on the index will not equal those available under a guaranteed fixed interest rate may, when weighed with other risk factors, dissuade the fund from making such an investment. A need therefore exists for a debt instrument with features that mitigate investment risks to institutional investors.

### SUMMARY

A system and a method for an indexed debt instrument mitigates risk perceived by an institutional investor acting as administrator of an eligible employee benefit plan when the indexed debt instrument is issued by a bank insured by the Federal Deposit Insurance Corporation (FDIC) in response to a deposit made by the institutional investor in the bank. The risk is mitigated, at least in part, by pass-through of FDIC insurance protecting the deposit. The insurance passes through the plan administrator to protect the interest of each member of the plan in the deposit, up to a defined legal limit.

### BRIEF DESCRIPTION OF THE DRAWINGS

FIG. 1 is a block diagram showing a system with components that cooperate to enable production and management of an indexed debt instrument.

FIG. 2 is a block diagram of a guaranteed investment contract management system for the system of FIG. 1.

FIG. 3 is a block diagram illustrating an investment system for an indexed debt instrument.

FIG. 4 is a diagram showing a system and method for selling an indexed debt instrument investment to an institutional investor.

### DETAILED DESCRIPTION OF THE PREFERRED EMBODIMENTS

An indexed debt instrument is described in this specification. Such an instrument may be in the form of a guaranteed investment contract (also called a GIC), a bank investment contract (BIC), a certificate of deposit (CD), or any equivalent thereof. The indexed debt instrument is issued by a bank or savings association insured by the FDIC (hereinafter, an “insured bank”), and the instrument may be brokered by a third party to an investor. The investor is an institutional investor with authority to invest funds of an eligible employee benefit plan. Such authority includes the authority to deposit the funds of an eligible employee plan in an insured bank. An eligible employee benefit plan is one eligible for pass-through of FDIC insurance to protect the interests of the plan's participants in the deposit made by the institutional investor in an insured bank. An institutional investor is thus an organization acting as an administrator or a nominee of an eligible employee benefit plan, a state or local agency charged with the investment of eligible employee benefit plan assets, or any equivalent thereof. Exemplary eligible employee benefit plans include, but are not necessarily limited to, those defined by the Employee Retirement Income Security Act (ERISA) and the Internal Revenue Code (IRC). An eligible employee benefit plan may be embodied as a pension plan, a retirement fund, a profit-sharing plan, a deferred compensation plan, or any equivalent.

This specification is directed to a debt instrument wherein a guaranteed return may be based upon an index. For example, the guaranteed return may be the greater of a fixed minimum coupon or a variable index-linked return over some period of time (“contract period”). In any case in which the guaranteed return is based in whole, in part, or in the alternative on an index, the debt instrument is refereed to as an “indexed debt instrument.” Indexing is a feature of the debt instrument that distributes the risk of unfavorable market events more evenly between the issuer and investor than would be the case with a guaranteed rate of interest. The indexed debt instrument described in this specification may be characterized by an initial deposit in an insured bank, a contract period, and a selected index. The indexed debt instrument is managed by calculating an initial allocation of the deposit into principal and return amounts, and by calculating an investment strategy. The indexed debt instrument may further be characterized by a limit on returns, such as a cap, a participation rate, a spread, or any equivalent thereof. According to the investment strategy, one or more orders are transmitted for investment of the principal amount in assets with long-term fixed yields, and one or more orders are transmitted for investment of the return amount in assets with short term yields determined by market activity related to the selected index. The investment strategy may be recalculated to accommodate short term changes in market volatility and/or interest rates, and, if used, the return limit may be recalculated at the same time.

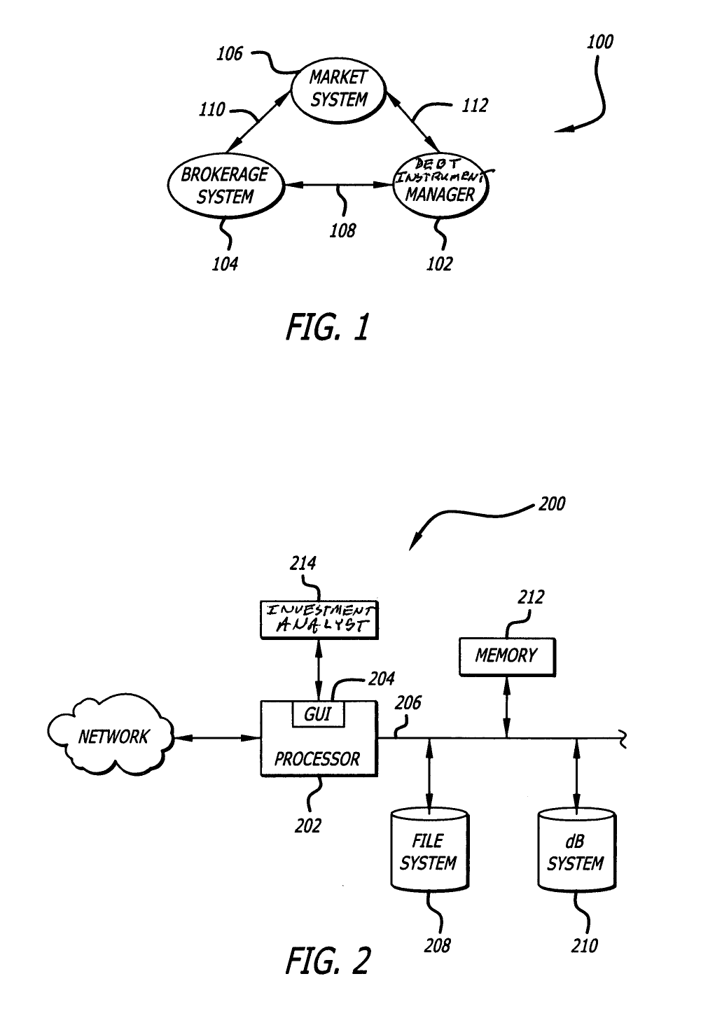

As shown in FIG. 1, the functions and acts that are set forth in this specification may be implemented in a system 100 constituted of one or more enterprise computing systems, including, for example and without limitation, a debt instrument management enterprise system 102, a securities brokerage enterprise system 104, and at least one market enterprise system 106. The debt instrument management enterprise system 102 and the brokerage enterprise system 104 are linked to conduct automated financial transactions by a communications link 108; the brokerage enterprise system 104 and the at least one market enterprise system 106 are linked to conduct automated securities transactions by a communications link 110; the debt instrument management enterprise system 102 and at least one market enterprise system 106 are linked to provide financial and market information to the debt instrument management enterprise system 102 by a communications link 112. The communications links 108 and 110 include interface and communications resources for formatting and communicating transaction information, while the respective enterprise systems that they link include processing resources for conducting financial and securities transactions by means of the transaction information communicated therebetween. The communications link 112 includes interface and communications resources for formatting and communicating market and financial information.

The debt instrument management enterprise system (“manager”) 102 includes a debt instrument management and transaction system; the brokerage enterprise system (“brokerage”) 104 includes a securities transaction system; and the at least one market enterprise system (“market”) 106 includes a securities trading system and, typically, a financial reporting service. The manager 102 and the brokerage 104 may be components of a single system or distinct enterprise system entities that conduct financial transactions whereby the brokerage 104 maintains various investment portfolios and conducts various securities transactions with respect to those portfolios in response to orders from the manager 102, and reports portfolio activity to the manager 102. The at least one market 106 may have an integral brokerage component, such as a seat on an exchange possessed by the brokerage 104. The market 106 provides the brokerage 104 with access to automated trading of securities. The market 106 also has or has access to a financial and market information system from which subscribers including the manager 102 obtain information relating to economic, market and financial activity.

A system for managing an indexed debt instrument may be a general purpose computer system programmed to execute procedures and functions to be described below. A method for managing an indexed debt instrument may be implemented in a software program embodied in an Excel spreadsheet or written in the C++ and/or Java programming languages. Of course, the programmed computer system and the method may also be embodied in a special purpose processor provided as a set of one or more chips. Further, there may be a program product constituted of a program of computer instructions stored on a tangible article of manufacture that causes a computer or a processor to execute the method. The tangible article of manufacture may be constituted of one or more fixed or portable storage devices, such as magnetic or optical disks, or it may be constituted of one or more nodes in a network.

FIG. 2 illustrates a system 200 for managing one or more indexed debt instruments so as to obtain returns derived from changes in the value of an index. Preferably the returns are derived from increases (positive swings) in the index's value. However, it is also contemplated that value could be derived from losses (negative swings) in the value of the index under certain conditions, and such possibilities are intended to be within the scope of this specification. The operations performed by the system 200 constitute a method for management of the indexed debt instrument. The system 200 is implemented in processing architecture integrated into the enterprise computing system of a debt instrument manager, for example the manager 102 of FIG. 1. The specific implementation of the manager's enterprise computing system is a matter of design choice by the reasonably skilled artisan. Nevertheless, the system 200 may entail a centrally-controlled computer system, a server-based system, a work station, a desk top computer, or an internet service computing system with the capability of communicating externally of the manager with one or more brokerages and/or markets. The system 200 may include processing, graphical user interface (GUI), bus, file, database and memory components, 202, 204, 206, 208, 210, and 212, that receive input information, conduct calculations and transactions, transmit, store, and retrieve information within the system 200, conduct exchanges of information with one or more brokerages, issue orders, and cause the receipt, transfer and aggregation of cash, bonds, certificates, accounts, securities, derivatives, interest, or equivalents. The system 200 may be operated by one or more investment analysts 214 authorized to use the system. The system 200 is enabled by a network connection 215 to access external systems via a network 216. Such external systems may include one or more brokerage and market enterprise systems such as described above. The system 200 is designed and programmed to:

receive and process economic, financial, and market information;

manage and administer debt instruments, including indexed debt instruments;

receive and process deposits;

conduct investment transactions with one or more brokerages;

calculate investment strategies;

issue orders to brokerages for principal investment transactions; and

issue orders to brokerages for index investment transactions.

Although the system 200 is illustrated and described in terms of a single index, the intent is to show the system at its most elemental level in order to foster a clear understanding of how it works. In practice, a debt instrument manager could employ means to apply the system 200 to more than one index for one or more debt instruments.

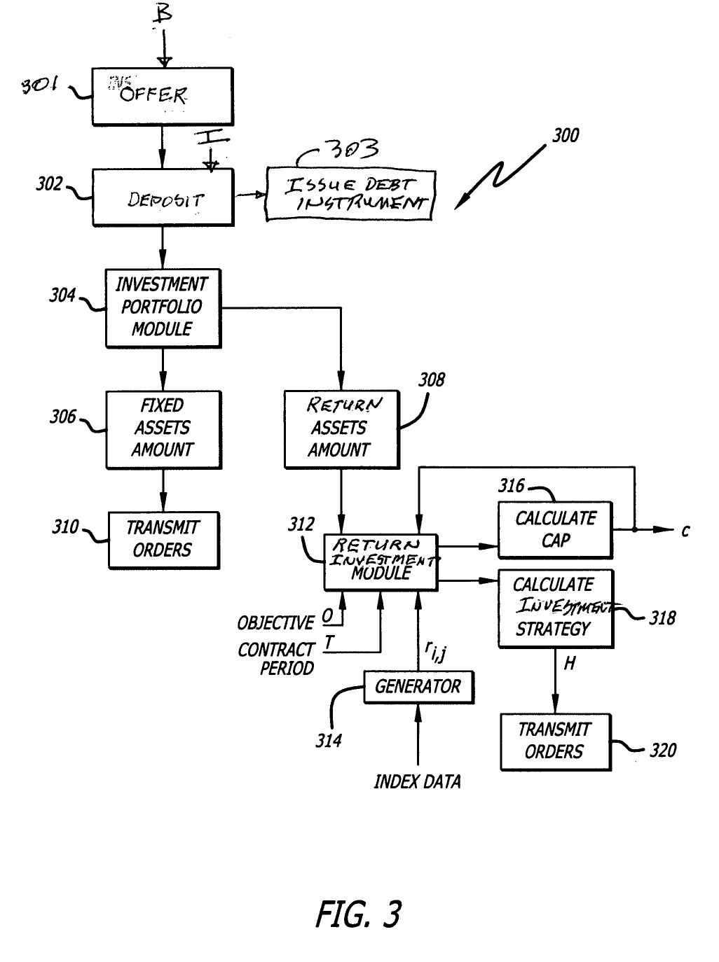

The system 200 includes one or more processing modules embodied in one or more computer programs, files, and data distributed among elements of the system 200. Certain of those modules constitute an investment system 300 illustrated in FIG. 3. Connections between the modules represent data and/or control transferred between modules either unidirectionally or bidirectionally. In the description, such data will be referred to in terms of information that it represents. In FIG. 3, an institutional investor I receives an offer 301 from an insured bank B to sell indexed debt instruments. The offer includes disclosure of information necessary to assist the institutional investor in making a decision to invest in the offered debt instruments. The offer may be communicated by conventional means including a writing, a printed prospectus, a portable storage device, a network, email, or any equivalent means.

Continuing with the description of FIG. 3, as the indexed debt instrument is negotiated, the institutional investor and insured bank may agree on, among other things, an investment objective, an index to which the debt instrument is linked, a minimum investment, a target contract principal amount, and a time or period T at the expiration of which repayment of the debt (the deposit) and distribution of any gains realized from appreciation of the index will occur. The terms of the debt instrument may provide for changing the objective during the term of the debt instrument under defined conditions. When the institutional investor accepts the offered debt instrument by making the deposit 302 with the insured bank, the debt instrument is issued at 303 by the insured bank to the institutional investor. The deposit 302 may be conveyed to the insured bank by conventional means including check, draft, electronic transfer, or equivalent. The deposit is received by an investment portfolio module 304. Based upon an allocation process, the investment portfolio module 304 functions as an initial portfolio calculator to divide the deposit into amounts for investment in fixed assets 306 and return assets 308. The fixed assets amount is designated for investment in one or more fixed assets whose book yields are known. Such fixed assets may comprise, for example and without limitation, bonds, contracts, and/or money market accounts and other forms of deposit bearing fixed rates of return over designated periods of time. Presuming that an objective is preservation of the deposit amount, the investment portfolio module 304 determines a fixed assets amount that will, when invested in fixed assets, produce a return at least equal to the deposit amount at the expiration of T. One or more orders for investment of the fixed assets amount may be transmitted to a brokerage by a data transmitter 310.

Continuing with the description of FIG. 3, the return assets amount 308 produced by the investment portfolio module is input to a return investment module 312 together with data S indicating a selected debt instrument strategy, a value indicating the period T, and data for selected objective return investment parameters. The selected objective return investment parameters used by the return assets module constitute the link that ties the debt instrument to the index. Optionally, the selected return investment parameters may include, for example and without limitation, derivatives based upon the index. Such derivatives may include, by way of further example, European options (calls and puts exercised only on the day the options expire) on the index. Data regarding such parameters may be obtained, for example, in the form of daily prices for European options in one or more selected derivatives from a market enterprise system such as the Chicago Board of Trade. One may generate sets of forecast returns r_{i,j} (such as forecast values for European options) by subjecting the data for a current objective market parameter (such as a daily European option price on a derivative of the index) to a generator 314 whose operation is based on some assumption about how option prices change during a short time period, say one month from the date of a current European option price. For example and without limitation, the generator 314 may be constituted of a log normal generator. The sets of forecast returns r_{i,j} are provided to the hedging module 312.

With further reference to FIG. 3, using the inputs described above, the return investment module 312 may also have or use a calculator 316 to calculate a return limit, such as a cap, and an investment calculator 318 to calculate a return investment strategy. With the return investment strategy, the debt instrument management system 200 is enabled by a data transmitter 320 to transmit orders to a brokerage for equity transactions that implement the return investment strategy. The return investment strategy may use a return limit such as a cap. In such a case, the return investment module 312 may have or use the calculator 316 to calculate a return limit.

A detailed return investment method for an indexed debt instrument is not described or illustrated here. However, a GIC investment strategy described and illustrated in the parent application is illustrative of a return investment strategy for an indexed debt instrument that is based on hedging using options and a cap.

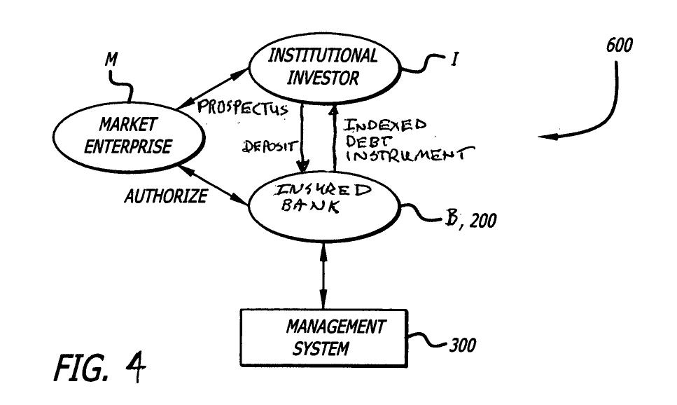

A system and method for selling an indexed debt instrument to an institutional investor I is illustrated in FIG. 4. The institutional investor I acts as administrator of an eligible employee benefit plan. An insured bank B issues one or more debt instruments in which the institutional investor I invests funds of the eligible employee benefit by depositing those funds in the insured bank B.

Continuing with the description of FIG. 4, other enterprises may be involved in brokering a sale transaction resulting in the insured bank B issuing an indexed debt instrument to the institutional investor I. In this regard, a marketing enterprise M with a staff of investment experts maintains brokerage and/or agency relationships with insured banks, such as the insured bank B, that issue indexed debt instruments. The marketing enterprise M markets investment instruments, including indexed debt instruments, to potential institutional investors, such as the institutional investor I. Still other enterprises may be involved in the marketing of an indexed debt instrument to the institutional investor I. Preferably, the insured bank B contracts with or otherwise authorizes the marketing enterprise M to offer indexed debt instruments issued by the insured bank B. In return, the marketing enterprise M receives a flat fee, a commission, points, or some other form of compensation for each indexed debt instrument issued by the insured bank B to an institutional investor resulting from brokerage activity by the marketing enterprise M. The consideration paid by the insured bank B to the marketing enterprise M for sale of an indexed debt instrument may be in the form of a one-time payment, or may comprise a sequence of payments during the term of the debt instrument contract. The marketing enterprise M conveys an offer of an indexed debt instrument to the institutional investor I, directly or through an intermediary (not shown). The institutional investor I accepts the offer and an indexed debt instrument is issued by the insured bank B to the institutional investor I. The insured bank B compensates the marketing enterprise M. Thereafter, the insured bank B may itself administer and manage the indexed debt instrument using the system 200, 300 described above, or may contract therefor.

In connection with the offer of the debt instrument made by or on behalf of the insured bank B, the institutional investor I is given information regarding the debt instrument by standard means such as a prospectus. A prospectus is a document containing a formal offer to sell investment products; it contains the facts that an investor needs to make an informed investment decision. In the case of the indexed debt instruments described above, the prospectus is prepared by or for the insured bank B and provided to the institutional investor I. Included in the information necessary for the institutional investor I of the to make an informed decision whether or not to deposit funds of an eligible employee benefit plan for a debt instrument is information regarding “pass-through” of deposit insurance guaranteed by the Federal Deposit Insurance Corporation in respect of a deposit made by the institutional investor I in the insured bank B. In this regard, FDIC insurance protecting the deposit passes through the plan administrator (the institutional investor I) to protect the interest of each member of the eligible employment benefit plan in the deposit, up to a defined legal maximum. Currently, the maximum is set by public law at $100,000, although this is not intended to limit any invention described herein solely to this amount. Thus, for example, the deposit of $10,000,000 of eligible employee benefit plan ZZ in the insured bank B by the institutional investor I for an indexed BIC or CD will result in each member of the plan having his or her share in the deposit being protected against loss resulting from failure of the insured bank B, up to the legal limit set by the FDIC (now $100,000).

Although the invention has been described with reference to one or more presently preferred embodiments, it should be understood that various modifications can be made without departing from the spirit of the invention. Accordingly, the invention is limited only by the following claims.

1. A method for managing an indexed debt instrument issued by a bank insured by a government agency for an institutional investor acting as administrator of an eligible employee benefit plan, comprising:
informing the institutional investor of pass-though of deposit insurance to members of the eligible employee benefit plan for funds deposited by the institutional investor in the insured bank to purchase the indexed debt instrument;
receiving a deposit from the institutional investor for purchase of the indexed debt instrument;
determining a time T for duration of the indexed debt instrument;
calculating fixed assets and return assets for the debt instrument such that the sum of the fixed assets and the return assets equals the deposit;
calculating a return investment strategy responsive to an index over T;
transmitting one or more orders for investment of fixed assets in assets having fixed returns; and
transmitting one or more orders for investment of return assets according to the return investment strategy.

2. The method of claim 1, further comprising:
recalculating the return investment strategy over T; and
transmitting one or more orders for investment of return assets according to the recalculated return investment strategy.

3. The method of claim 2, further comprising, periodically recalculating the fixed income assets and the return assets.

4. A method for managing an indexed debt instrument issued by a bank insured by a government agency for an institutional investor acting as administrator of an eligible employee benefit plan, comprising:
submitting an offer to sell to the institutional investor an indexed debt instrument for the eligible employee benefit plan;
the offer including information informing the institutional investor of pass-through of deposit insurance to members of the eligible employee benefit plan for funds deposited by the institutional investor in the insured bank to purchase the indexed debt instrument;
receiving a deposit of eligible employee benefit funds from the institutional investor for purchase of the indexed debt instrument;
determining a time T for duration of the indexed debt instrument;
calculating fixed assets and return assets for the debt instrument such that the sum of the fixed assets and the return assets equals the deposit;
calculating a return investment strategy responsive to an index over T;
transmitting one or more orders for investment of fixed assets in assets having fixed returns; and
transmitting one or more orders for investment of return assets according to the return investment strategy.

5. The method of claim 4, further comprising:
recalculating the return investment strategy over T; and
transmitting one or more orders for investment of return assets according to the recalculated return investment strategy.

6. The method of claim 5, further comprising, periodically recalculating the fixed income assets and the return assets.

7. The method of claim 5, the offer being communicated to the institutional investor by a broker.

8. A system for managing an indexed debt instrument issued by a bank insured by a government agency to an institutional investor acting as administrator of an eligible employee benefit plan, comprising:
means for informing the institutional investor of pass-though of deposit insurance to members of the eligible employee benefit plan for funds deposited by the institutional investor in the insured bank to purchase the indexed debt instrument;
means for receiving a deposit from the institutional investor for purchase of the indexed debt instrument;
means for calculating fixed assets and return assets for the debt instrument such that the sum of the fixed assets and the return assets equals the deposit;
means for calculating a return investment strategy responsive to an index over a time T for duration of the debt instrument;
means for transmitting one or more orders for investment of fixed assets in assets having fixed returns; and
means for transmitting one or more orders for investment of return assets according to the return investment strategy.

9. The system of claim 8, wherein:
the means for calculating a return investment strategy is further for recalculating the return investment strategy over T; and
the means for transmitting one or more orders for investment of return assets is further for transmitting one or more orders for investment of return assets in according to the recalculated return investment strategy.

10. The system of claim 9, wherein the means for calculating fixed assets and return assets is further for periodically recalculating the fixed assets and the return assets.

11. A method of investing funds of an eligible employee benefit plan in an indexed debt instrument issued by a bank insured by a government agency an eligible employee benefit plan, comprising:
offering an indexed debt instrument issued by a bank insured by a government agency through a marketing enterprise to an administrator eligible to pass deposit insurance for the bank's accounts to members of the eligible employee benefit plan;
receiving funds of the eligible employee benefit plan from the administrator to purchase the indexed debt instrument; and,
issuing the indexed debt instrument to the administrator.

12. The method of claim 11, further including managing the indexed debt instrument by:
calculating fixed assets and return assets for the debt instrument such that the sum of the fixed assets and the return assets equals the deposit;
calculating a return investment strategy responsive to an index over a time T for duration of the indexed debt instrument;
transmitting one or more orders for investment of fixed assets in assets having fixed returns; and
transmitting one or more orders for investment of return assets according to the return investment strategy.
